(19) United States
(12) Patent Application Publication
(10) Pub. No.: US 2020/0142982 A1
(43) Pub. Date: May 7, 2020

(54) MANAGE CONFLICTS IN A SOFTWARE AND HARDWARE INFRASTRUCTURE

(71) Applicant: International Business Machines Corporation, Armonk, NY (US)

(72) Inventor: Karthika Manickam, Bengaluru (IN)

(21) Appl. No.: 16/177,718

(22) Filed: Nov. 1, 2018

(51) Int. Cl. G06F 17/30; G06F 9/50

(52) U.S. Cl. CPC G06F 17/30371; G06F 9/5027; G06F 17/30368

(57) ABSTRACT

A method of operating a computing infrastructure is provided. The computing infrastructure includes computing resources, a central repository connected to the computing resources, and a change request tool connected to the central repository. The method includes: receiving, by the central repository, a later change request for at least one of the computing resources; determining, by the central repository, which of the computing resources would be affected by the later change request; determining, by the central repository, that the later change request conflicts with an earlier change request; and invalidating the later change request.

### BACKGROUND

Many modern computing infrastructures include heterogeneous software and hardware resources. For example, a single infrastructure can include hardware servers, virtual machines, application servers, databases, load balancers, operating systems, middleware, and software applications. In addition, the computing resources can exist at a data center, in a cloud computing environment, or a combination thereof (i.e., a hybrid environment).

Many modern software and hardware resources are updated and/or maintained periodically. When such changes are being made to an individual resource, its operability can be affected, which can in turn affect other resources that rely upon it. In a heterogenous stack of resources, these updates could be presented for different resources at different times, and/or updates for multiple different resources could be presented at the same time. Because of the many interconnections and relationships within a computing structure, scheduling updates to individual members thereof can be difficult.

### SUMMARY

According to some embodiments, a method of operating a computing infrastructure is provided. The computing infrastructure includes computing resources, a central repository connected to the computing resources, and a change request tool connected to the central repository. The method includes: receiving, by the central repository, a later change request for at least one of the computing resources; determining, by the central repository, which of the computing resources would be affected by the later change request; determining, by the central repository, that the later change request conflicts with an earlier change request; and invalidating the later change request.

According to some embodiments, a change management system includes computing resources; a central repository connected to the plurality of computing resources, the central repository including, for each of the computing resources, identification information, ownership information, and relationship information with respect to at least another one of the computing resources; and a change request tool connected to the central repository for requesting a change to at least one of the computing resources.

According to some embodiments, a computer program product for memory management is provided. The computer program product includes a computer readable storage medium, the computer readable storage medium having program instructions embodied therewith, the programs instructions configured, when executed by at least one computer, to cause the at least one computer to perform a method. The method includes: receiving, by a central repository of a computing infrastructure, a later change request, from a change request tool, for at least one of computing resource of the computing infrastructure that is connected to the central repository; determining, by the central repository, which of the computing resources would be affected by the later change request; determining, by the central repository, that the later change request conflicts with an earlier change request; and invalidating the later change request.

### BRIEF DESCRIPTION OF THE DRAWINGS

FIG. 1 shows a schematic view of a computing infrastructure including a change management system.

FIG. 2 shows a flowchart of a method of using the change management system of FIG. 1.

FIG. 3 shows a visual representation of some of the responsibilities and relationships of the equipment and personnel associated with central repository of the change management system of FIG. 1.

FIG. 4 shows a dependency-based lock management system for the change management system of FIG. 1.

FIG. 5 shows a high-level block diagram of an example computer system that may be used in implementing embodiments of the present disclosure.

FIG. 6 depicts a cloud computing environment according to an embodiment of the present disclosure.

FIG. 7 depicts abstraction model layers according to an embodiment of the present disclosure.

### DETAILED DESCRIPTION

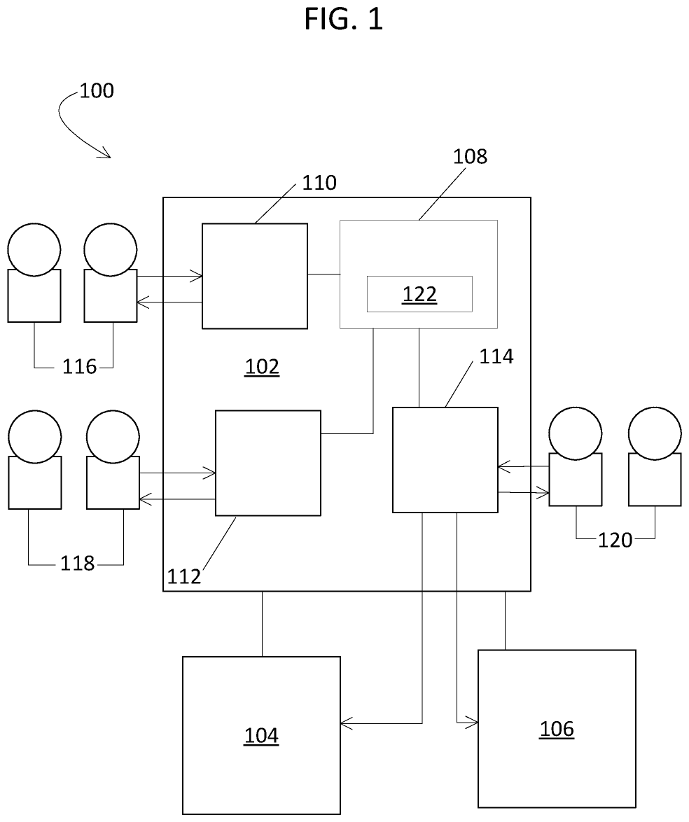

FIG. 1 shows a schematic view of a computing infrastructure 100. Computing infrastructure 100 includes global change management system (GCMS) 102, on-premises computing resources 104, and cloud computing resources 106. GCMS 102 includes central repository 108, change submission tool 110, change approval tool 112, and change implementation tool 114. Interacting with computing infrastructure 100 are a plurality of users including change requesters 116, change owners 118 (which can also be a delivery manager, account owner, client and/or project executive), and change implementors 120, which specifically interact with tools 110, 112, and 114, respectively. In some embodiments, users 116, 118, and 120 are all different people, although in other embodiments, one person can assume multiple or all of the user roles.

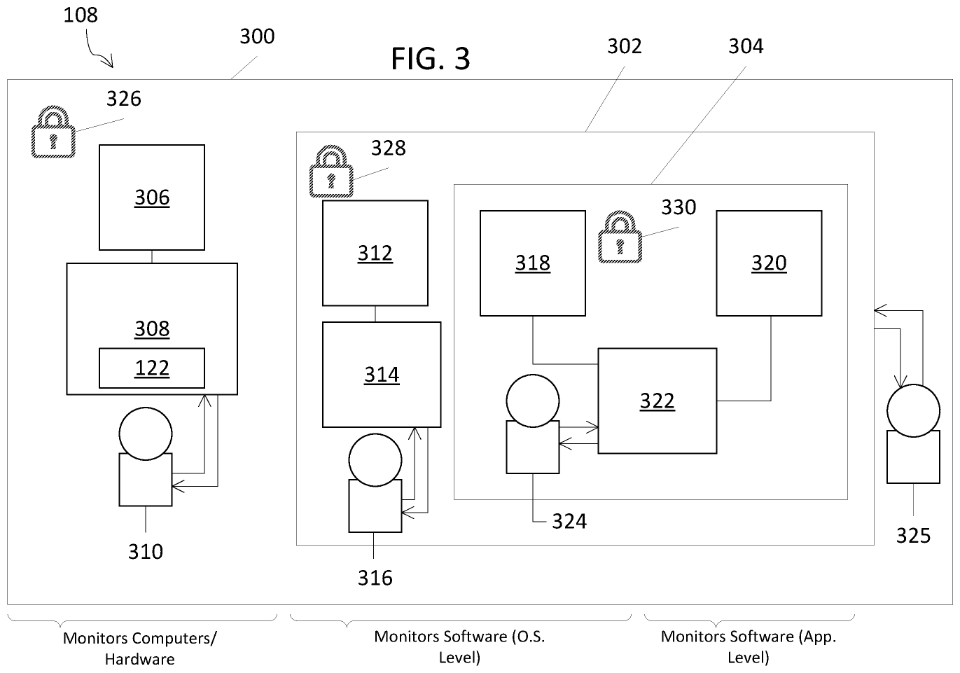

In the illustrated embodiment, central repository 108 includes a database 122 (shown in FIG. 3) of information regarding all of the computing resources 104 and 106 (e.g., each device, server, appliance, and software application) associated with computing infrastructure 100. More specifically, each computing resource (including those later joining computing infrastructure 100) is labeled with a unique identification code so that additional information can be associated therewith. For example, for each computing resource, database 122 can include information regarding the respective change owner 118; locks due to scheduled changes, outages, maintenance, and/or downtime; and the relationships (e.g., hierarchical or dependent) with other computing resources.

In the illustrated embodiment, tools 110, 112, and 114 are each connected to central repository 108. Thereby, changes made to computing infrastructure 100 can be scheduled in an orderly manner because all of the changes are directed through central repository 108. Such a system allows for a well-defined interaction point for the users 116, 118, and 120 and resolves scheduling issues that may arise when some or all of the affected computing resources are indisposed or when there are multiple changes presented for overlapping time frames.

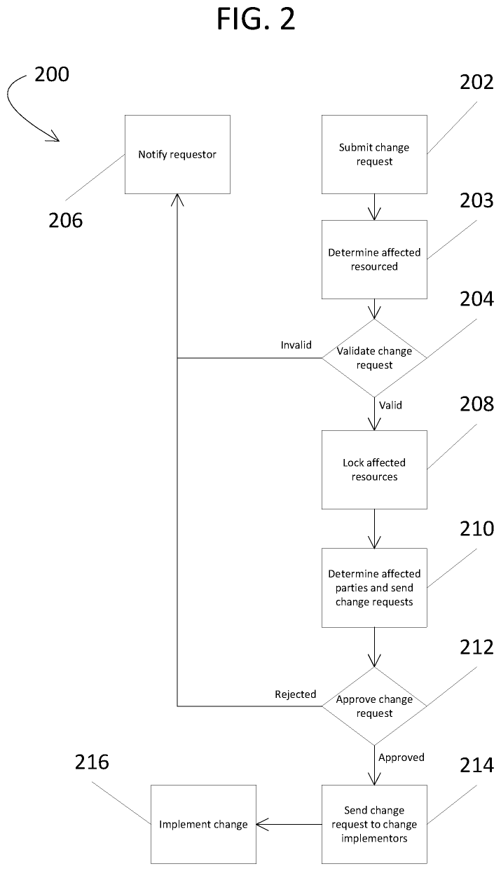

FIG. 2 shows a flowchart of method 200 of using GCMS 102 of FIG. 1 (with reference to some of the items shown therein). At box 202, a change request is received from a change requester 116 through change submission tool 110. The change request can include information, such as, but not limited to, start and end time of the change, whether a restart is required, a backup plan, etc., along with a resource ID of the computing resource to be changed. At box 203, which resources that will be directly affected by the change request (e.g., the resources to which the change is directed, as indicated by the resource ID in the change request) as well as the resources that will be indirectly affected by the change request (e.g., the resources that will be affected by any outages or interruptions of the directly-affected resources due to the change implementation) are determined. Then at box 204, GCMS 102 validates the change request if there are no other conflicting changes scheduled for any of the directly or indirectly affected devices at the given time requested. If there is a conflict with one or more of the affected devices at the requested time (e.g., another change occurring), then GCMS 102 will invalidate the change request. In the latter case, change requester 116 will be notified of the rejection of their change request at box 206.

If the change request is validated by GCMS 102, then at box 208, each of the computing resources that are affected (directly or indirectly) by the change are “locked” in the schedule of GCMS 102. Thereby, the time for the change will be reserved for those resources so that other conflicting change requests will be rendered invalid by GCMS 102.

At box 210, the respective change owners 118 of the affected computing resources are determined using the database of GCMS 102, and those change owners 118 are notified of the change request. At box 212, input from each change owner 118 can be received to approve or reject the change request. If any one of the change owners 118 rejects the change request, then change requester 116 will be notified of the rejection of their change request at box 206. If all of the change owners 118 approve, then at box 214, the change request is sent to change implementor 120. At box 216, the change is implemented in on-premises computing resources 104 and/or cloud computing resources 106. In some alternate embodiments, an approved change that can be implemented automatically can skip box 214 and go directly from box 212 to box 216.

Thereby, method 200 allows for the orderly processing of change requests and implementation of change requests when appropriate. In particular, method 200 can automatically reject change requests that conflict with existing change requests, allow change owners 118 to have their input considered in approving a change request that would affect them, and notify change requesters 116 if their change request has been denied.

FIG. 3 shows a visual representation of some of the responsibilities and relationships of the equipment and personnel associated with central repository 108 of GCMS 102 of FIG. 1. In the illustrated embodiment, central repository 108 includes resource/asset domain 300, information technology (IT) applications/software domain 302, and application release domain 304. Resource/asset domain 300 encompasses IT applications/software domain 302 and application release domain 304, and IT applications/software domain 302 encompasses application release domain 304.

Resource/asset domain 300 monitors the hardware resources 306 (for example, resources 104 and 106) in computing environment 100 (shown in FIG. 1). Resource/asset domain 300 includes resource/asset management system 308 which itself includes database 122. Infra administrator 310 can interact with resource/asset management system 308, for example, to maintain, monitor, add to, and/or subtract from database 122.

IT applications/software domain 302 monitors software and virtual machines 312 on the operating system level that are used in computing environment 100. IT applications/software domain 302 includes IT applications/software management system 314, and platform administrator 316 can interact with IT applications/software management system 314. Application release domain 304 monitors middleware resources 318 and software resources/applications 320 on the application level that are used in computing environment 100. Application release domain 304 includes application release management system 322, and middleware administrator 324 can interact with application release management system 322. Release manager 325 can interact with IT applications/software domain 302 as well. Release manager 325 manages application releases as well as upgrades to current software. Therefore, release manager 325 uses information about software and virtual machines 312, middleware resources 318, and software resources/applications 320 to determine which resources/assets are affected by a given software initialization or upgrade.

Each of domains 300, 302, and 304 includes one of locks 326, 328, and 330, respectively. Locks 326, 328, and 330 can be activated by GCMS 102 (shown in FIG. 1) and applied to certain resources/assets 306, 314, 318, and 320 for certain time periods (for example, thirty-minute blocks of time starting on the hour and the half-hour). Thereby, central repository 108 can prevent overbooking a resource/asset 306, 314, 318, or 320 for multiple changes at the same time.

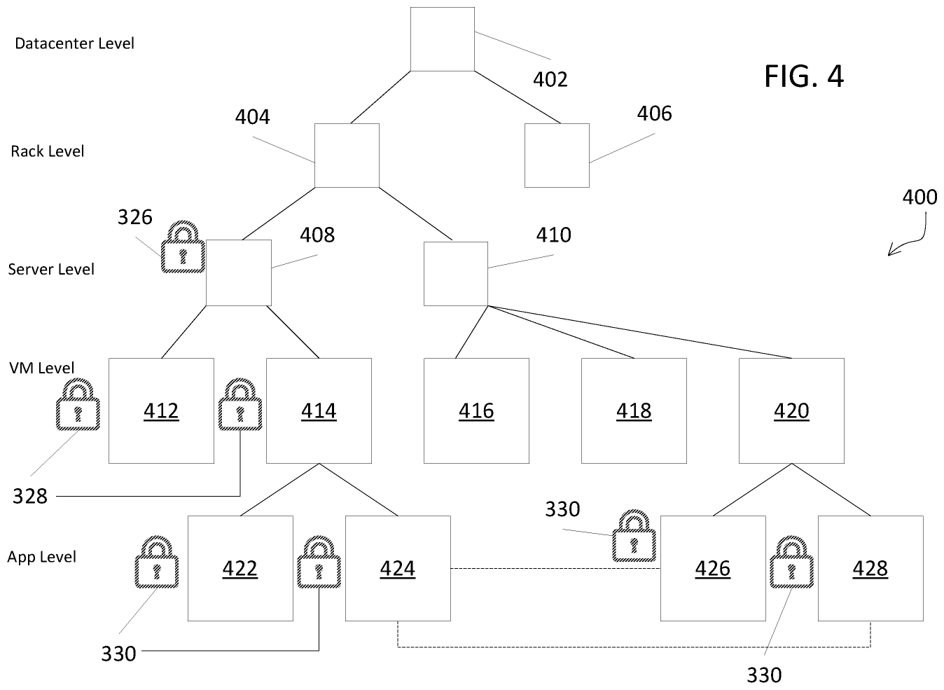

FIG. 4 shows an example dependency-based lock management hierarchy 400 for central repository 108 of GCMS 202 (shown in FIG. 1). Hierarchy 400 graphically demonstrates example dependencies of some resources/assets on others in some embodiments of computing environment 100. More specifically, when a resource/asset is down (for example, when it is receiving a change), other subordinate resources/assets can be affected such that making changes to the subordinate resources/assets should not be attempted.

In the illustrated embodiment, the computing environment comprises datacenter 402; racks 404 and 406; servers 408 and 410; virtual machines 412, 414, 416, 418, and 420; and applications 422, 424, 426, and 428. All of resources/assets 402-428 can be, for example, a portion or all of on-premises computing resources 104 (shown in FIG. 1). According to hierarchy 400, applications 422-428 are dependent on virtual machine 414 and 420, respectively, and virtual machines 412-420 are dependent on servers 408 and 410. In turn, servers 408 and 410 are dependent on rack 404, and racks 404 and 406 are dependent on datacenter 402.

The illustrated embodiment shows an example where server 408 is scheduled to be updated at a given future timeslot. Therefore, GCMS 102 has put lock 326 on server 408, preventing further changes to be scheduled during the given timeslot. Accordingly, GCMS 102 has determined that resources/assets 412, 414, and 422-428 would also be affected by this change. So lock 328 has been put on virtual machines 412 and 414, and lock 330 has been put on applications 422 and 424. While applications 426 and 428 are not dependent on application 424 in a hierarchical sense, applications 426 and 428 are dependent on application 424 for other reasons. Thus, lock 330 has been applied to applications 426 and 428 as well.

In the case where there was a subsequent change request for the given timeslot, then GCMS 102 would consult hierarchy 400 of central repository 108 to determine it if would involve or affect any of the locked resources/assets 408, 412, 414, or 422-428. If so, GCMS 102 would automatically reject the subsequent change request (as discussed previously with respect to box 204 in FIG. 2). If not, then GCMS 102 would use hierarchy 400 to determine the affected resources/assets, which can be used along with ownership data also in central repository 108 to determine the affected parties (as discussed previously with respect to boxes 208 and 210 of FIG. 2). Therefore, such a system can prevent change-scheduling conflicts in computing infrastructure 100 automatically.

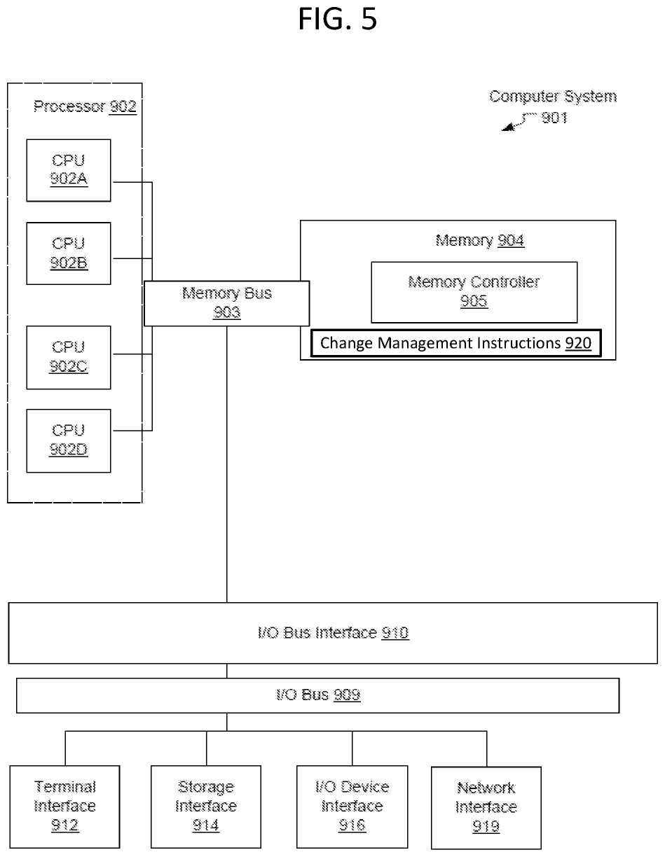

Referring now to FIG. 5, shown is a high-level block diagram of an example computer system (i.e., computer) 901 that may be used in implementing one or more of the methods or modules, and any related functions or operations, described herein (e.g., using one or more processor circuits or computer processors of the computer), in accordance with embodiments of the present disclosure. In some embodiments, the components of the computer system 901 may comprise one or more CPUs 902, a memory subsystem 904, a terminal interface 912, a storage interface 914, an I/O (Input/Output) device interface 916, and a network interface 919, all of which may be communicatively coupled, directly or indirectly, for inter-component communication via a memory bus 903, an I/O bus 909, and an I/O bus interface unit 910.

The computer system 901 may contain one or more general-purpose programmable central processing units (CPUs) 902A, 902B, 902C, and 902D, herein generically referred to as the processer 902. In some embodiments, the computer system 901 may contain multiple processors typical of a relatively large system; however, in other embodiments the computer system 901 may alternatively be a single CPU system. Each CPU 902 may execute instructions stored in the memory subsystem 904 and may comprise one or more levels of on-board cache.

In some embodiments, the memory subsystem 904 may comprise a random-access semiconductor memory, storage device, or storage medium (either volatile or non-volatile) for storing data and programs. In some embodiments, the memory subsystem 904 may represent the entire virtual memory of the computer system 901 and may also include the virtual memory of other computer systems coupled to the computer system 901 or connected via a network. The memory subsystem 904 may be conceptually a single monolithic entity, but, in some embodiments, the memory subsystem 904 may be a more complex arrangement, such as a hierarchy of caches and other memory devices. For example, memory may exist in multiple levels of caches, and these caches may be further divided by function, so that one cache holds instructions while another holds non-instruction data, which is used by the processor or processors. Memory may be further distributed and associated with different CPUs or sets of CPUs, as is known in any of various so-called non-uniform memory access (NUMA) computer architectures. In some embodiments, the main memory or memory subsystem 904 may contain elements for control and flow of memory used by the Processor 902. This may include a memory controller 905.

Although the memory bus 903 is shown in FIG. 5 as a single bus structure providing a direct communication path among the CPUs 902, the memory subsystem 904, and the I/O bus interface 910, the memory bus 903 may, in some embodiments, comprise multiple different buses or communication paths, which may be arranged in any of various forms, such as point-to-point links in hierarchical, star or web configurations, multiple hierarchical buses, parallel and redundant paths, or any other appropriate type of configuration. Furthermore, while the I/O bus interface 910 and the I/O bus 909 are shown as single respective units, the computer system 901 may, in some embodiments, contain multiple I/O bus interface units 910, multiple I/O buses 909, or both. Further, while multiple I/O interface units are shown, which separate the I/O bus 909 from various communications paths running to the various I/O devices, in other embodiments some or all of the I/O devices may be connected directly to one or more system I/O buses.

In some embodiments, the computer system 901 may be a multi-user mainframe computer system, a single-user system, or a server computer or similar device that has little or no direct user interface but receives requests from other computer systems (clients). Further, in some embodiments, the computer system 901 may be implemented as a desktop computer, portable computer, laptop or notebook computer, tablet computer, pocket computer, telephone, smart phone, mobile device, or any other appropriate type of electronic device.

In the illustrated embodiment, memory subsystem 904 further includes change management instructions 920. The execution of change management instructions 920 enables computer system 901 to perform one or more of the functions described above in managing change requests (for example, method 200, shown in FIG. 2).

It is noted that FIG. 5 is intended to depict representative components of an exemplary computer system 901. In some embodiments, however, individual components may have greater or lesser complexity than as represented in FIG. 5, components other than or in addition to those shown in FIG. 5 may be present, and the number, type, and configuration of such components may vary.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

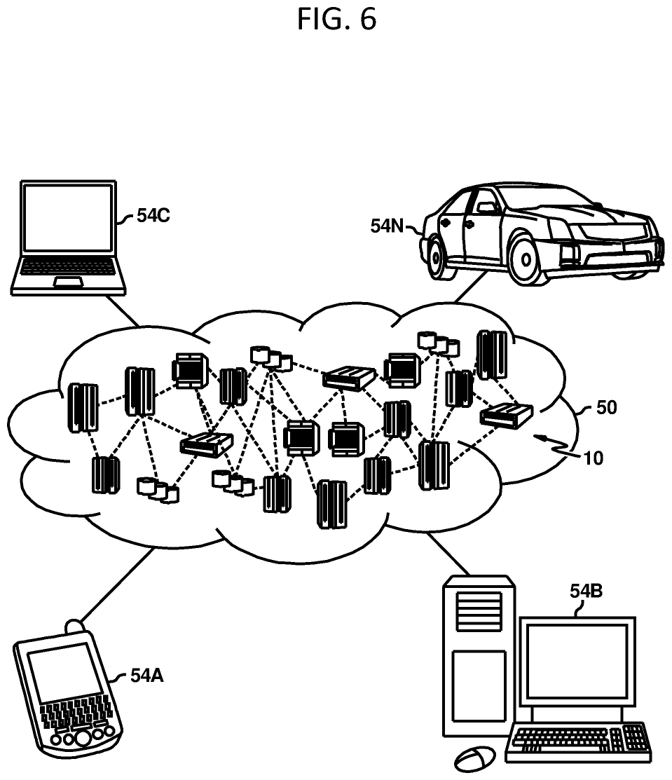

Referring now to FIG. 6, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 6 are intended to be illustrative only and that computing nodes 10 and cloud computing environment 50 can communicate with any type of computerized device over any type of network and/or network addressable connection (e.g., using a web browser).

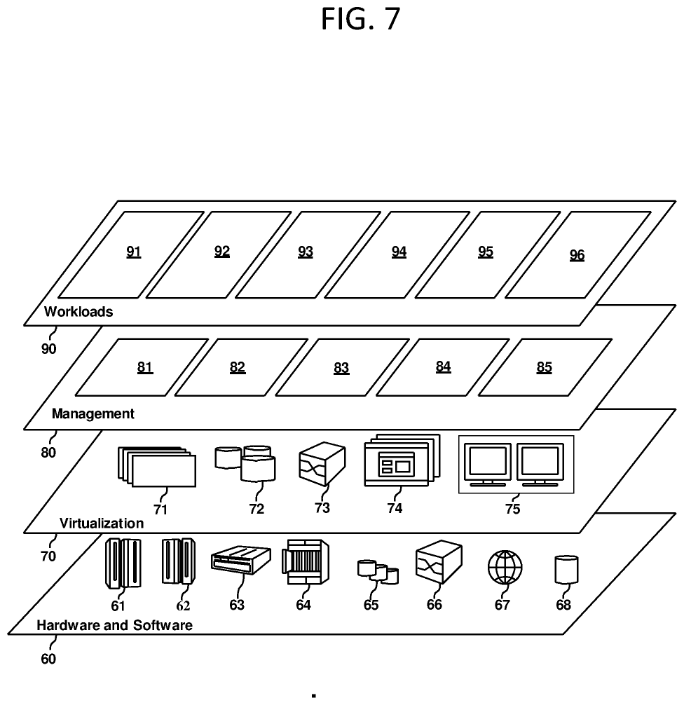

Referring now to FIG. 7, a set of functional abstraction layers provided by cloud computing environment 50 (FIG. 6) is shown. It should be understood in advance that the components, layers, and functions shown in FIG. 7 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and change management 96.

The descriptions of the various embodiments of the present disclosure have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method of operating a computing infrastructure comprising a plurality of computing resources, a central repository connected to the plurality of computing resources, and a change request tool connected to the central repository, the method comprising:
receiving, by the central repository, a later change request for at least one of the plurality of computing resources;
determining, by the central repository, which of the plurality of computing resources would be affected by the later change request;
determining, by the central repository, that the later change request conflicts with an earlier change request; and
invalidating the later change request.

2. The method of claim 1, further comprising:
receiving, by the central repository, a subsequent change request for at least one of the plurality of computing resources;
determining, by the central repository, which of the plurality of computing resources would be affected by the subsequent change request;
determining, by the central repository, that the subsequent change request is not in conflict with the earlier change request; and
locking the affected ones of the plurality of computing resources that would be affected by the subsequent change request.

3. The method of claim 2, further comprising:
determining, by the central repository, at least one owner of the plurality of computing resources that would be affected by the subsequent change request; and
notifying, by the central repository, the at least one owner of the subsequent change request.

4. The method of claim 3, further comprising:
receiving, by the central repository, approval of the subsequent change request from the at least one owner; and
notifying, by the central repository, at least one change implementor of the subsequent change request.

5. The method of claim 1, wherein the later change request is invalidated because at least one of the plurality of computing resources that would be affected by the later change request is locked by the central repository.

6. The method of claim 1, wherein:
the earlier change request includes a first timeslot during which the earlier change request is to be implemented;
the later change request includes a second timeslot during which the later change request is to be implemented; and
the second timeslot overlaps the first timeslot.

7. The method of claim 1, further comprising:
notifying, by the central repository, a change requester that submitted the later change request of the invalidation of the later change request.

8. A change management system comprising:
a plurality of computing resources;
a central repository connected to the plurality of computing resources, the central repository including, for each of the computing resources, identification information, ownership information, and relationship information with respect to at least another one of the plurality of computing resources; and
a change request tool connected to the central repository for requesting a change to at least one of the plurality of computing resources.

9. The change management system of claim 8, further comprising:
an approval tool connected to the central repository for approving the requested change.

10. The change management system of claim 8, further comprising:
an implementation tool connected to the central repository for implementing the requested change.

11. The change management system of claim 8, wherein the central repository further comprises:
lock information for each of the computing resources, the lock information representing timeslots in which each of the computing resources is unavailable for the change.

12. The change management system of claim 8, wherein the central repository further comprises:
a database that includes the identification information, ownership information, and relationship information; and
a resource/asset management system configured to be used to maintain, monitor, add to, and/or subtract from the database.

13. The change management system of claim 8, wherein the central repository further comprises:
an information technology applications/software management system for monitoring at least some of the plurality of computing resources on an operating system level.

14. The change management system of claim 8, wherein the central repository further comprises:
an application release management system for monitoring at least some of the plurality of computing resources on the application level.

15. A computer program product for memory management, the computer program product comprising a computer readable storage medium, the computer readable storage medium having program instructions embodied therewith, the programs instructions configured, when executed by at least one computer, to cause the at least one computer to perform a method comprising:
receiving, by a central repository of a computing infrastructure, a later change request, from a change request tool, for at least one of a plurality of computing resources of the computing infrastructure that is connected to the central repository;
determining, by the central repository, which of the plurality of computing resources would be affected by the later change request;
determining, by the central repository, that the later change request conflicts with an earlier change request; and
invalidating the later change request.

16. The computer program product of claim 15, further comprising:
receiving, by the central repository, a subsequent change request for at least one of the plurality of computing resources;
determining, by the central repository, which of the plurality of computing resources would be affected by the subsequent change request;
determining, by the central repository, that the subsequent change request is not in conflict with the earlier change request; and
locking the affected ones of the plurality of computing resources that would be affected by the subsequent change request.

17. The computer program product of claim 16, further comprising:
determining, by the central repository, at least one owner of the plurality of computing resources that would be affected by the subsequent change request; and
notifying, by the central repository, the at least one owner of the subsequent change request.

18. The computer program product of claim 17, further comprising:
receiving, by the central repository, approval of the subsequent change request from the at least one owner; and
notifying, by the central repository, at least one change implementor of the subsequent change request.

19. The computer program product of claim 15, wherein:
the earlier change request includes a first timeslot during which the earlier change request is to be implemented;
the later change request includes a second timeslot during which the later change request is to be implemented; and
the second timeslot overlaps the first timeslot.

20. The computer program product of claim 15, further comprising:
notifying, by the central repository, a change requester that submitted the later change request of the invalidation of the later change request.
